(19) United States
(12) Patent Application Publication
(10) Pub. No.: US 2022/0106832 A1
(43) Pub. Date: Apr. 7, 2022

(54) BLIND ASSEMBLY

(71) Applicant: LES ENTREPRISES SMARTLUX INC., Saint-Laurent (CA)

(72) Inventor: Fan ZHOU, Montreal (CA)

(21) Appl. No.: 17/493,075

(22) Filed: Oct. 4, 2021

(30) Foreign Application Priority Data
Oct. 5, 2020 (CA) 3095206

(51) Int. Cl. E06B 9/42; E06B 9/56

(52) U.S. Cl. CPC E06B 9/42; E06B 2009/2452; E06B 2009/425; E06B 9/56

(57) ABSTRACT

A blind assembly for building openings is provided. The blind assembly is switchable from having one roller tube to more roller tubes by changing the number of end plates. The blind assembly may also include a chain guide to guide the chains from the roller tubes such that the chains do not interfere with each other.

### CROSS REFERENCE TO RELATED APPLICATIONS

This application claims priority of Canadian patent application No. 3095206, filed on Oct. 5, 2020, the content of which is incorporated herein by reference in its entirety.

### TECHNICAL FIELD

This disclosure relates to blinds for building openings in general, for example, roller shades or roller blinds. In particular, this disclosure relates to blinds that are switchable from having one roller tube and one panel of blind material associated therewith to having more roller tubes and panels of blind materials associated therewith.

### BACKGROUND

Consumers of blinds for building openings have various needs.

Some consumers prefer blinds with a blind, such as cloth, that can be released or retracted by the rotation of a roller tube. Some consumers prefer venetian blinds.

Some consumers prefer blinds with multiple pieces of blinds or shades, for example, of different thickness or light-blocking properties, such that the amount of light allowed through is adjustable while preserving privacy, or a combination of venetian blinds and shades.

Thus, there is a need for a blind assembly for building openings, for example, doors and windows, that can switch between accommodating one blind to more blinds by changing the number of roller tubes and the panels of blind materials associated therewith.

### SUMMARY

A blind assembly that can be switched from having one roller tube and one blind to having more roller tubes and blinds is provided. The blinds may include one or more panels of blind materials. The panels may include shades, venetian blinds, or a combination thereof. The blind materials may include cloth, plastic, metal or a combination thereof.

In some embodiments, the blind assembly includes a first upper end plate that is configured to have the first end of a first rail installed thereon. A first lower end plate is configured to removably connect to the first end plate. The second end plate is configured to have the first end of a second rail installed thereon.

In some embodiments, the blind assembly also includes a second upper end plate configured to have the second end of the first rail installed thereon such that the first rail is installed between the first and the second upper plates. The blind assembly further includes a second lower end plate that removably attaches to the second upper end plate. The second lower end plate is configured to have the second end of the second rail installed thereon such that the second rail is installed between the first and the second lower end plates.

In some embodiments, a first clutch is disposed at the first end of the first rail, and the first end of the first rail engages a first chain that extends from the first clutch. A second clutch is disposed at the first end of the second rail, and the first end of the second rail engages a second chain that extends from the second clutch.

In some embodiments, a chain guide is provided such that the first chain and the second chain do not interfere with each other.

### BRIEF DESCRIPTION OF THE DRAWINGS

Reference will now be made, by way of example, to the accompanying drawings which show example embodiments of the present application, and in which:

FIG. 1 is a perspective view of one embodiment of the blind assembly.

FIG. 2 is a side view of the blind assembly of FIG. 1.

FIGS. 3A and 3B are the top view of the blind assembly of FIG. 1 and the A-A sectional views thereof.

FIG. 4 is an exploded view of the blind assembly of FIG. 1.

FIG. 5 is a front view, side view and A-A sectional view of one end of the blind assembly of FIG. 1.

FIGS. 6A, 6B, and 6C are the right side view, front view, and back view of one embodiment of the lower end plate of the blind assembly.

FIGS. 7A, 7B, and 7C are the left side view, back view, and front view of one embodiment of the lower end plate of the blind assembly.

FIGS. 8A, 8B, and 8C are the front view, back view, and right side view of the chain guide.

FIGS. 9A, 9B, 9C, 9D, and 9E show the installation of the lower end plate of FIGS. 6A, 6B, and 6C to one embodiment of the upper end plate.

FIGS. 10A, 10B, and 10C show the lower end plate of FIGS. 7A, 7B, and 7C connected to one embodiment of the upper end plate.

FIG. 11 is the front view, side view and A-A sectional view of one end of the blind assembly of FIG. 1 with the idler ends connected to the end plates.

FIGS. 12A, 12B, 12C, 12D and 12E show the process of attaching the chain guide of FIGS. 8A, 8B, and 8C to the end plate of FIGS. 6A, 6B, and 6C.

### DESCRIPTION

In the Summary above and in the Description, and in the accompanying drawings, reference is made to particular features (including method steps) of the disclosure. It is to be understood that the disclosure in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

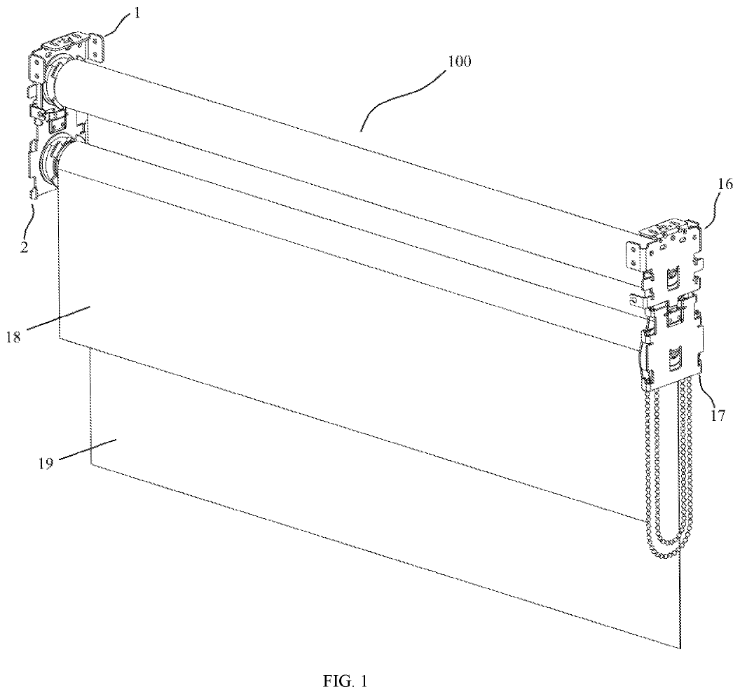

FIG. 1 shows one embodiment of the blind assembly 100, which includes an end plate 16 and an end plate 17 at one end, and an end plate 1 and an end plate 2 at the other end. Two panels of blind materials 18 and 19 are also included in the blind assembly 100. The panels may include shades, venetian blinds, or a combination thereof. The blind materials may include cloth, plastic, metal, wood, bamboo, or a combination thereof.

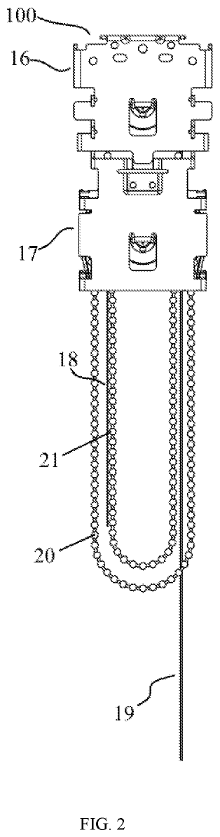

FIG. 2 shows a side view of the blind assembly. The end plate 17 is connected to the end plate 16. A chain or cord 20 extends outside of the chain or cord 21.

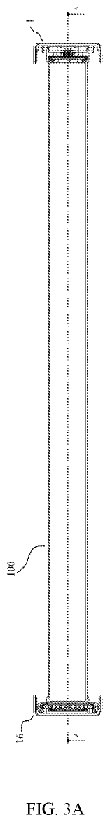

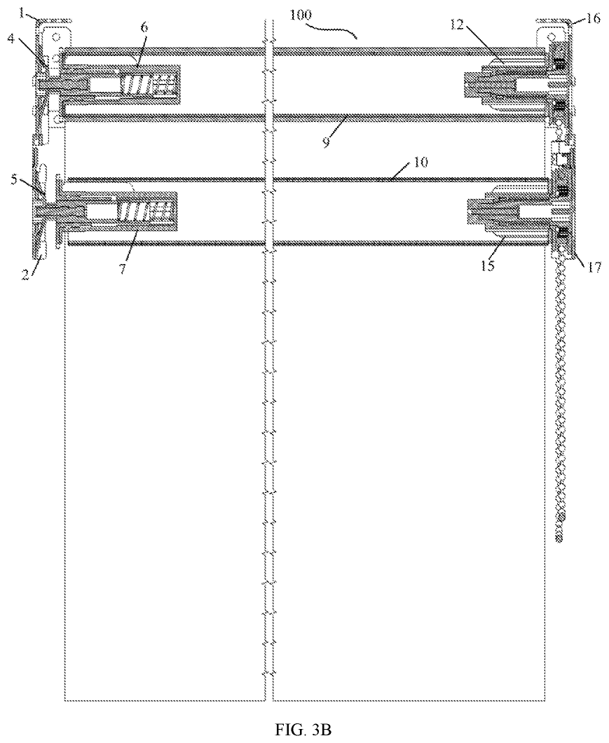

FIG. 3A is a top view of the blind assembly, showing end plates 1 and 16 disposed at the two ends of the blind assembly 100.

FIG. 3B shows the A-A sectional view of the blind assembly 100. There is a rail 9 and a rail 10. When the blind assembly 100 is installed, the rail 9 is disposed above the rail 10. In some embodiments, the rail 9 and rail 10 are spaced apart horizontally when the blind assembly 100 is installed. In some embodiments, the rail 10 is horizontally and vertically offset from the rail 9.

The rail 9 is installed between the end plate 16 and the end plate 1. The rail 9 is installed to the end plate 16 through a clutch 12 and to the end plate 1 through an idler end 6. The rail 10 is installed between the end plate 17 and the end plate 2. The rail 10 is installed to the end plate 17 through a clutch 15 and to the end plate 2 through an idler end 7. The idler end 6 is connected to the end plate 1 through a retainer 4. The idler end 7 is connected to the end plate 2 through a retainer 5. In some embodiments, the rail 10 is installed on the end plate 17 and/or 2 directly. In some embodiments, the rail 9 is installed on the end plate 16 and/or the end plate 1 directly. In some embodiments, the end plate 1 is identical to or the mirror image of the end plate 16. In some embodiments, the end plate 1 is substantially the same as the end plate 16 while being configured for installation of the other end of the rail 9.

In some embodiments, the end plate 17 is connected to the end plate 1 directly and the end plate 2 is connected to the end plate 16 directly. In some embodiments, the rail 10 is installed to the end plate 17 through an idler end and to the end plate 2 through a clutch. In some embodiments, the blind assembly 100 is set up such that the clutches 12 and 15 are at opposite ends of the blind assembly 100.

In some embodiments, when there are more than two rails in the blind assembly 100, the clutches may be configured on one side of the blind assembly 100, alternating on the sides of the blind assembly 100, alternating on the sides of the blind assembly in groups, or otherwise as desired. In some embodiments, the idler ends are connected to the end plates directly without using retainers.

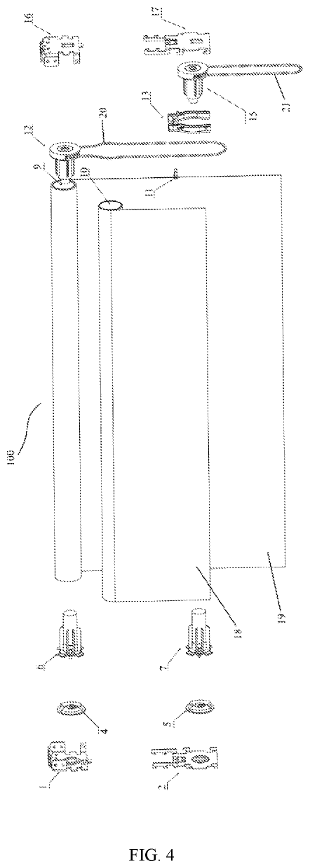

FIG. 4 shows an exploded view of the blind assembly 100 when it includes two rails 9 and 10. Retainers 4 and 5 are provided for connecting the idler ends 6 and 7 to the end plate 1 and the end plate 2. The panel 18 is attached to the rail 10, which is configured to engage the clutch 15. The panel 19 is attached to the rail 9, which is configured to engage the clutch 12.

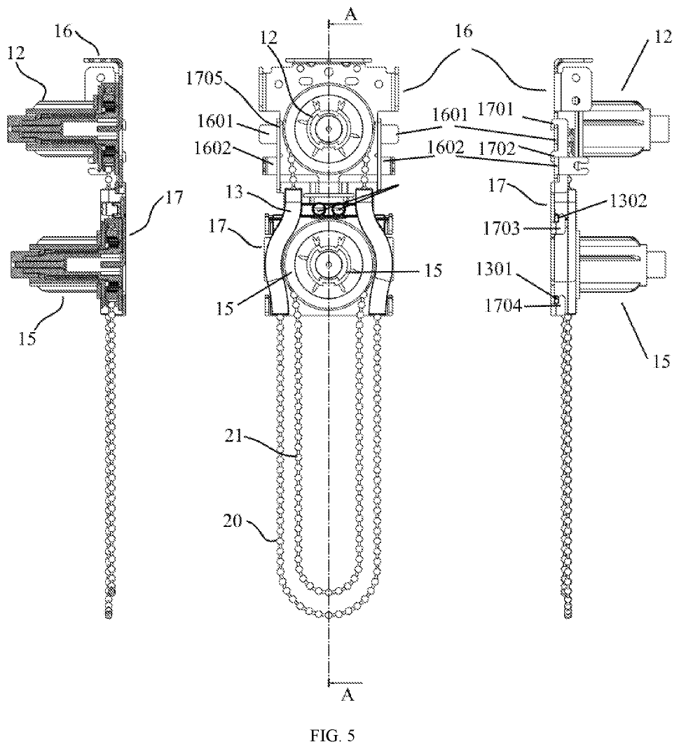

FIG. 5 shows the end plate 17 connected to the end plate 16. The end plate 16 includes a connection counterpart 1601 and a connection counterpart 1602, each of which includes two protrusions extending from the sides of the end plate 16. In some embodiments, the protrusions extend from the side of the end plate 16 on which the rail 9 or the clutch 12 is installed. In some embodiments, the protrusions extend from the side of the end plate 16 opposite the side the rail 9 or the clutch 12 is installed.

The end plate 17 includes a lower connection counterpart 1701 and a lower connection counterpart 1702, each includes two hook-shaped structures that are disposed opposite the surface for installation of the clutch 15, and extend upwardly to connect to the upper connection counterparts 1601 and 1602. In some embodiments, the connection counterparts 1701 and 1702 include hook-shaped structures that are disposed on the same side of the end plate 17 where the rail 10 or clutch 15 is installed.

The clutch 12 is disposed on the end plate 16 and the clutch 15 is disposed on the end plate 17.

A chain guide 13 guides the chain or cord 20 to the outside of the chain or cord 21 so that the chain or cord 20 does not interfere with the chain or cord 21. The chain guide 13 is attached to the end plate 17 with connectors 11 and the coupling counterparts 1301 and 1302 engaging the coupling counterparts 1703 and 1704. In some embodiments, the chain guard 13 is attached to the end plate 16 or both end plates 16 and 17.

In some embodiments, the chain guide 13 is configured to guide the chain or cord 20 to one side of the chain or cord 21.

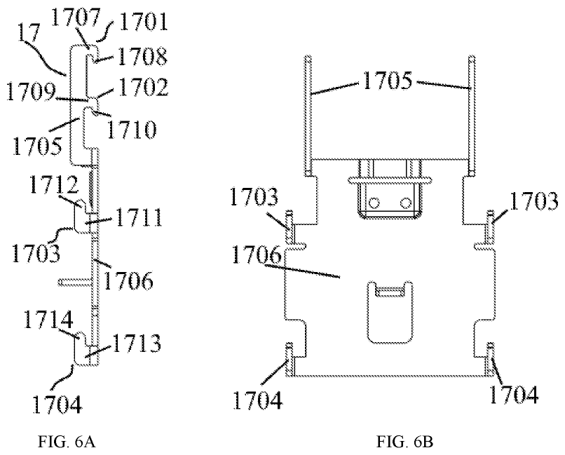

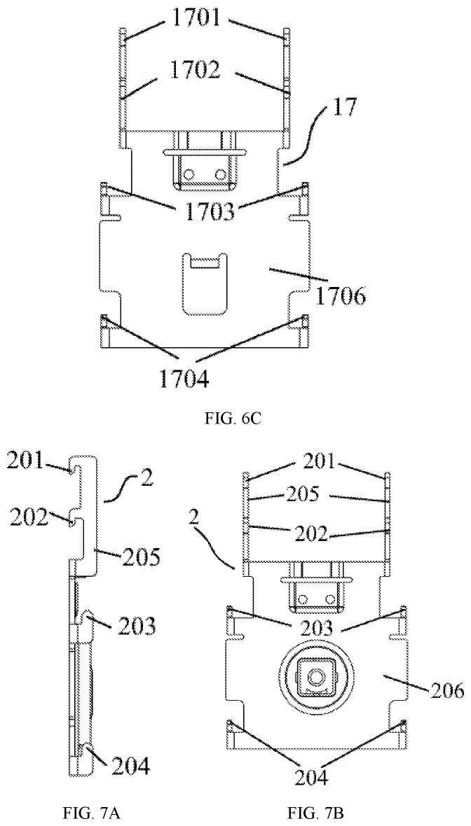

FIGS. 6A, 6B, and 6C show the views of one embodiment of the end plate 17. The end plate 17 includes a connection counterpart 1701 and a connection counterpart 1702 configured to engage the end plate 16. Each of the connection counterpart 1701 and the connection counterpart 1702 includes two hook-shaped structures. Each hook-shaped structure of the lower connection counterpart 1701 includes a horizontal extension 1707 that extends substantially perpendicularly from the body 1706 and a protrusion 1708 that extends downwardly substantially parallel to the body 1706. The Each hook-shaped structure of the lower connection counterpart 1702 includes a horizontal extension 1709 that extends substantially perpendicularly from the body 1706 and a protrusion 1710 extending downwardly substantially parallel to the body 1706. The body 1706 is substantially rectangular. In some embodiments, the body 1706 is circular, oval, stadium, or elliptical. Each of the end plates 1, 2, and 16, independently, may be of a similar shape.

The connection counterparts 1701 and 1702 are disposed on two arms 1705 extending vertically upwardly from the body 1706 of the end plate 17. The connection counterpart 1701 is disposed further away from the body 1706 than the connection counterpart 1702. The arms 1705 are shaped, sized, and spaced apart such that they do not interfere with the upper rail 9 when the end plate 17 is connected to the end plate 16. For example, the arms 1705 may be spaced apart for a distance larger than the diameter of the upper rail 9. As a result, the end plate 17 may be installed on the end plate 16 without removing the rail 9 or interfering with the upper rail 9. In some embodiments, there may be no arms, only one arm, or there may be more than two arms. In some embodiments, each of the arms, independently, may extend upwardly at a desired angle from the body 1706.

The end plate 17 also includes coupling counterpart 1703 and coupling counterpart 1704, which are configured to engage the chain guide 13. The coupling counterparts 1703 and 1704 are disposed on the same side of the body 1706 for installation of the rail 10. Each of the coupling counterparts 1703 and 1704 includes two U-shaped structure. Each U-shaped structure of the coupling counterpart 1703 includes a horizontal extension 1711 that extends substantially perpendicularly from the body 1706 and a protrusion 1714 that extends upwardly substantially parallel to the body 1706. In some embodiments, the end plate 17 does not include the coupling counterparts, for example when there is no need to engage the chain guide 13. In some embodiments, the end plate 17 includes only one coupling counterpart. In some embodiments, the end plate 17 includes more than two coupling counterparts. In some embodiments, each of the coupling counterparts 1703 and 1704, independently, includes one U-shaped structure or more than two U-shaped structure.

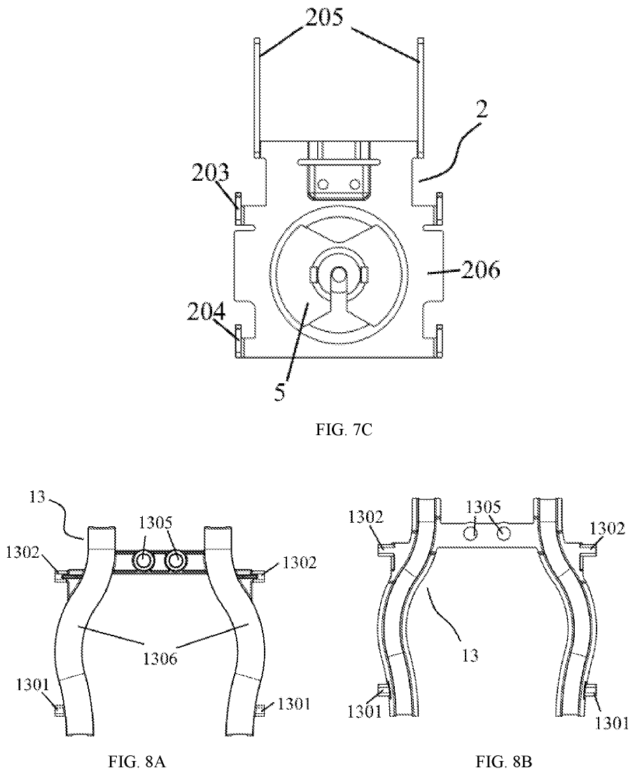

Reference is made to FIGS. 7A, 7B, and 7C, which show the left side, back, and front views of the end plate 2. Similar to the end plate 17, the end plate 2 includes a connection counterpart 201 and a connection counterpart 202, each including two hook-shaped structures, similar to the connection counterparts 1701 and 1702. In some embodiments, the end plate 2 may include only one connection counterpart. In some embodiments, the end plate 2 may include more than two connection counterparts. In some embodiments, each connection counterpart, independently, may include one or more structures to connect to the end plate 1. In some embodiments, each of the connection counterparts, independently, may include structures other than hook-shaped protrusions to connect to the end plate 1.

The connection counterparts 201 and 202 are disposed on two arms 205 extending vertically upwardly from the body 206 of the end plate 2. The two arms 205 are sized, shaped and spaced such that they do not interfere with the upper rail 9. For example, the arms 205 may be spaced apart for a distance larger than the diameter of the rail 9. As a result, the end plate 2 may be installed on the end plate 1 without removing the rail 9 or interfering with the rail 9. In some embodiments, there may be no arms, only one arm, or there may be more than two arms. In some embodiments, each of the arms, independently, may extend upwardly at a desired angle from the body 206.

The end plate 2 also includes the coupling counterparts 203 and 204. Each of the coupling counterparts 203 and 204 include two U-shaped structures similar to the coupling counterparts 1703 and 1704.

In some embodiments, the end plate 2 is substantially similar to the end plate 17 except each is configured to receive a different end of the rail 10. In some embodiments, the end plate 2 is identical to or a mirror image of the end plate 17. In some embodiments, the end plate 2 and the end plate 17 are exchangeable.

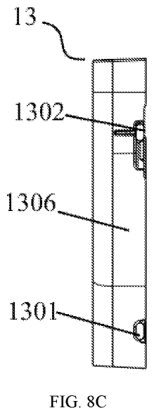

FIGS. 8A, 8B, and 8C show the front, back, and right side view of the chain guide 13. The chain guide 13 includes two chain paths 1306 that guide the cord 20 from the upper roller tube 9 such that the cord 20 does not interfere with the cord 21 from the lower roller tube 10 when the clutches 12 and 15 are disposed on the same side of the blind assembly 100. In some embodiments, the blind assembly 100 does not include the chain guide 13. For example, when the cords 20 and 21 are configured at different ends of the blind assembly 100, the chain guide 13 is not necessary. In some embodiments, the clutch 12 and the clutch 15 are configured such that the distance between the two sides of the chain 21 is larger than the distance between the two sides of the chain 20. For example, the clutch 12 may have a larger diameter than the clutch 15, or the chain 21 may engage a circumference of the clutch 12 that has a larger diameter than the circumference of the clutch 15 where the clutch 15 engages the chain 20.

The chain guide 13 also includes the coupling counterparts 1301 and 1302, each including two tabs extending outwardly from the chain paths 1306. The coupling counterparts 1301 and 1302 are configured to engage the coupling counterparts 1704 and 1703 such that the chain guide 13 can be coupled to the end plate 17 as shown in FIG. 5. The coupling counterpart 1301 and the coupling counterpart 1302 may also cooperate with, for example by engaging, the coupling counterparts 204 and 203 so that the chain guide 13 can be coupled to the end plate 2.

In some embodiments, the coupling counterparts 1301 and/or 1302 includes hook-shaped structure to engage the coupling counterparts 1703 and 1704. In some embodiments, one or more of the coupling counterparts 1301 and 1302 are configured for a hook and loop type of connection with the respective coupling counterparts 1703 and 1704. In some embodiments, the coupling counterparts 1703 and/or 1704, independently, includes hook-shaped structure while the coupling counterparts 1301 and/or 1302 correspondingly includes a tab such that the coupling counterparts 1703 and 1704 can engage the respective coupling counterparts 1301 and 1302.

The chain guide 13 also includes two apertures 1305 that are configured for the connectors 11 to pass through to connect the chord guide 13 to the end plate 17. In some embodiments, hot melt columns are inserted through the holes 1305, which are then heated to effect connection of the chain guide 13 to the end plate 17.

In some embodiments, the chain guide 13 does not include the apertures 1305. In some embodiments, the chain guide 13 does not include the coupling counterparts 1301 and 1302.

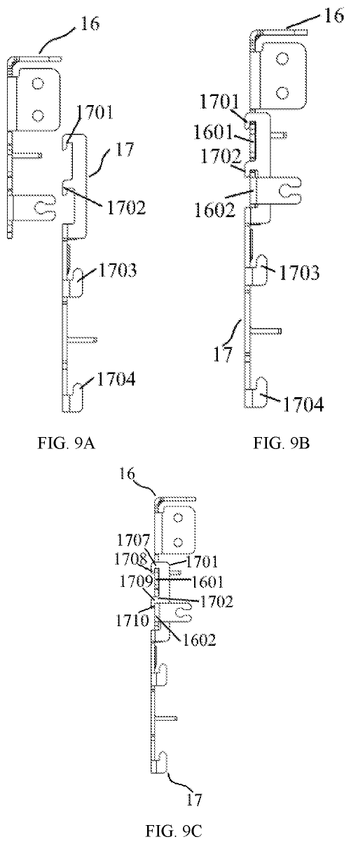

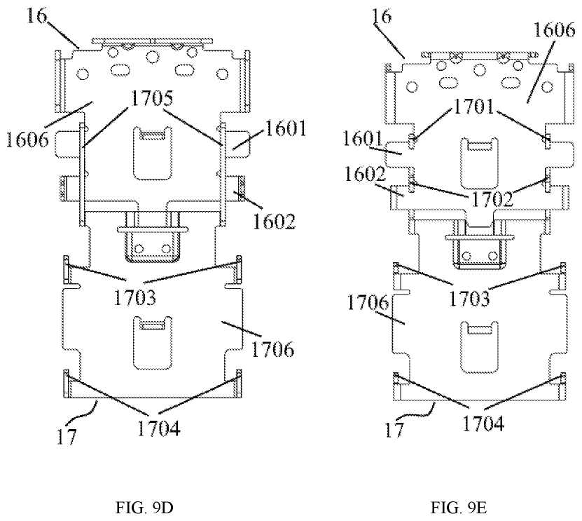

FIGS. 9A, 9B, 9C, 9D, and 9E illustrate the installation and removal of the end plate 17 to the end plate 16.

The end plate 17 is placed adjacent to the end plate 16 and the connection counterparts 1701 and 1702 are aligned with the connection counterparts 1601 and 1602. The end plate 17 is then lowered such that the connection counterpart 1701 engages the connection counterpart 1601 and the connection counterpart 1702 engages the connection counterpart 1602. The horizontal extension 1707 rests on the protrusion of the connection counterpart 1601 and the protrusion 1708 limits the movement of the end plate 17 away from the connection counterpart 1601. The horizontal extension 1709 of the connection counterpart 1702 rests on the protrusion of the connection counterpart 1602 and the protrusion 1710 limits the movement of the end plate 17 away from the connection counterpart 1602. As a result, the end plate 17 is attached to the end plate 16.

In some embodiments, the end plate 17 and the end plate 2 may be configured with other connection counterparts such that other end plates may be connected to the end plate 17 and the end plate 2, which allow the installation of additional roller tubes. As a result, the blind assembly 100 may include more than two roller tubes.

By reversing the steps, the end plate 17 can be removed from the end plate 16.

In some embodiments, the arms 1705 and/or the connection counterparts are configured such that the body 1606 of the end plate 16 and the body 1706 of the end plate 17 are coplanar when the end plates 16 and 17 are connected. In some embodiments, the arms 1705 and/or the connection counterparts are configured such that the body 1606 of the end plate 16 and the body 1706 of the end plate 17 are offset when the end plates 16 and 17 are connected.

In some embodiments, the end plate 17 may include only one connection counterpart. In some embodiments, the end plate 17 may include more than two connection counterparts. In some embodiments, each of the connection counterparts includes at least one C- or U-shaped structure with the opening facing downwardly. In some embodiments, each connection counterpart, independently, include one, two, three, four, or more structures to connect to the end plate 16. In some embodiments, each of the connection counterparts 1701 and 1702, independently, include one or more loop-like structures to connect to the upper connection counterparts 1601 and 1602.

In some embodiments, the connection counterparts 1601 and 1602 include hook-shaped or loop-shaped structure, while the connection counterparts 1701 and 1702 includes protrusions configured to engage the connection counterparts 1601 and 1602, respectively. In some embodiments, each of the connection counterparts 1701 and 1702, independently, includes one or more than two protrusions.

The end plate 2 can also be similarly connected to and removed from the end plate 1. In some embodiments, the end plate 2 can also be similarly connected to and removed from the end plate 16.

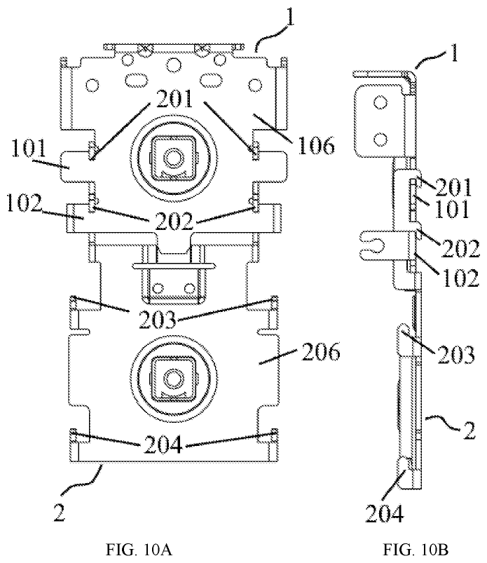

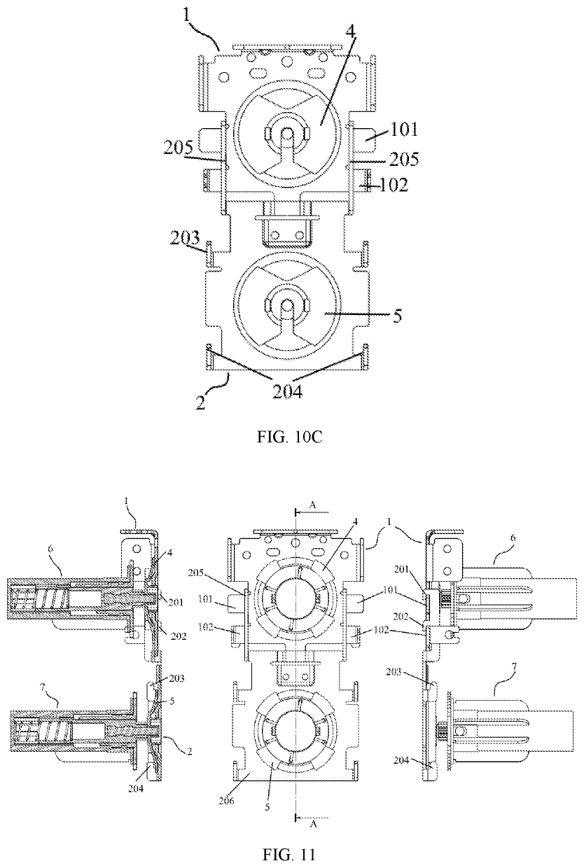

FIGS. 10A, 10B, and 10C show the end plate 2 connected to the end plate 1. The connection between the end plate 2 and the end plate 1 is similar to the connection between the end plate 17 and the end plate 16. The end plate 2 is connected to the end plate 1 when the connection counterparts 201 and 202 engage the connection counterparts 101 and 102. The configuration of the connection counterparts 101, 102, 201, and 202 may be altered in similar fashion as discussed with respect to the connection counterparts 1601, 1602, 1701, and 1702.

A retainer 4 is disposed on the end plate 1 for connection to the idler end 6 and a retainer 5 is disposed on the end plate 2 for connection to the idler end 7. In some embodiments, the blind assembly 100 does not include one or both of the retainers 4 and 5.

The end plate 2 may be connected to the end plate 1 in a manner similar to how the end plate 17 is connected to the end plate 16 as shown in FIGS. 9A, 9B, 9C, 9D, and 9E.

After the end plates 17 and 2 are installed, the roller tube 10 may be installed between the end plates 17 and 2.

FIG. 11 shows the end plate 2 connected to the end plate 1 and the idler ends 6 and 7 are connected to the end plate 1 and the end plate 2 by the retainers 4 and 5.

In some embodiments, the end plates 1 and 2 are directly connected to the idler ends 6 and 7 without using the retainers 4 and 5.

In some embodiments, the arms 205 and/or the connection counterparts are configured such that the body 106 of the end plate 1 and the body 206 of the end plate 2 are coplanar when the end plates 1 and 2 are connected. In some embodiments, the arms 205 and/or the connection counterparts are configured such that the body 106 of the end plate 1 and the body 206 of the end plate are offset when the end plates 1 and 2 are connected.

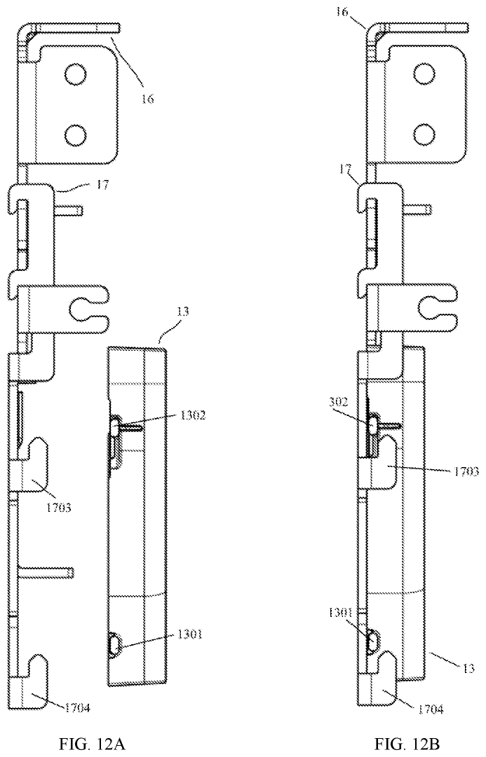

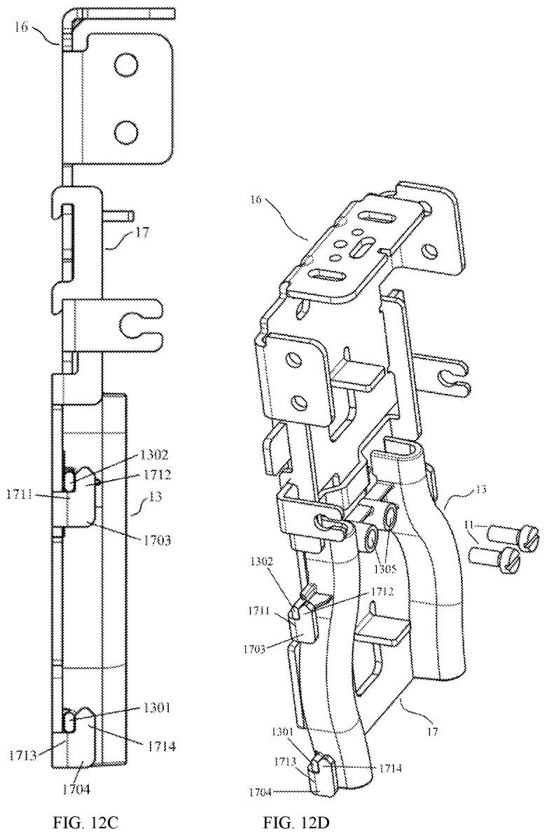

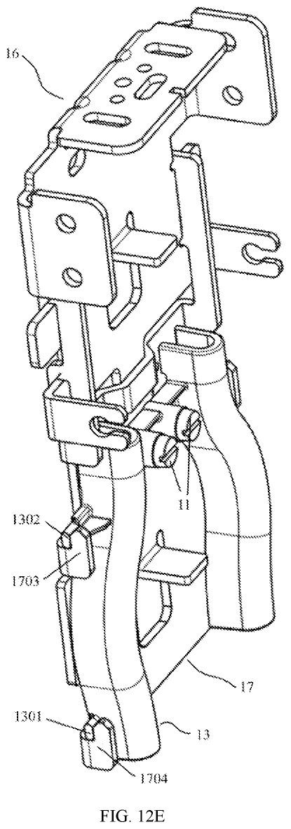

Reference is made to FIGS. 12A, 12B, 12C, 12D, and 12E. A process for attaching the chain guide 13 to the end plate 17 is disclosed. The chain guide 13 is aligned with the end plate 17. The chain guide 13 is then lowered such that the coupling counterpart 1301 engages the coupling counterpart 1704 and the coupling counterpart 1302 engages the coupling counterpart 1703. By lowering the chain guide 13 relative to the end plate 17, the tab of the coupling counterpart 1301 rests on the extension 1713 and the protrusion 1714 blocks the tab of the coupling counterpart 1301 from moving away from the body 1706. The tab of the coupling counterpart 1302 rests on the extension 1711 and the protrusion 1712 blocks the tab of the coupling counterpart 1302 from moving away from the body 1706. As such, the chain guide 13 is attached to the end plate 17.

Connectors 11 is then received through the apertures 1305 to assist the connection between the chain guide 13 and the end plate 17. The connectors 11 may be removable, for example screws or bolts. In some embodiments, the connectors 11 are permanent, such as rivets. In some embodiments, the chain guide 13 is attached by the connectors 11 only. In some embodiments, connectors 11 are not used. In some embodiments, adhesives are used in place of the connectors 11, for example, hot-melt adhesives, pressure-sensitive adhesive, contact adhesives, solvent-based adhesives, or polymer dispersion adhesives. In some embodiments, the connectors 11 are used in combination with adhesives.

By reversing the steps, the chain guide 13 can be removed from the end plate 17.

The blind assembly 100 comprises metal, plastic, rubber, wood, cloth, or a combination thereof.

The preceding discussion provides many example embodiments. The disclosure includes all reasonably combinations of the elements of the various embodiments.

The term “connected,” “attached to” or similar expression may indicate that the elements are directly connected to each other or connected through other components.

Although the embodiments have been described in detail, it should be understood that various changes, substitutions and alterations can be made herein.

Furthermore, the scope of the present application is not intended to be limited to the particular embodiments of the process, machine, manufacture, composition of matter, means, methods and steps described in the specification. As persons skilled in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A blind assembly, comprising:
a first upper end plate configured to effect installation of a first end of an upper rail; and
a first lower end plate removably connected to the first upper end plate, the first lower end plate configured to effect installation of a first end of a lower rail.

2. The blind assembly of claim 1, wherein:
the first upper end plate comprises a first upper connection counterpart,
the first lower end plate comprises a first lower connection counterpart; and
the first connection counterpart and the second connection counterpart cooperate such that the first lower end plate is removably connected to the first upper end plate.

3. The blind assembly of claim 2, wherein:
the first upper connection counterpart comprises at least one protrusion,
the first lower connection counterpart comprises at least one hook-shaped structure, each adapted to connect to a respective one of the at least one protrusion.

4. The blind assembly of claim 2, wherein:
the first lower connection counterpart is so sized and shaped such that the first lower connection counterpart is spaced apart from the upper rail when the first lower end plate and the first upper end plate are connected.

5. The blind assembly of claim 4, wherein:
the first lower connection counterpart comprises two hook-shaped structures, each of the hook-shaped structure disposed on a respective one of two arms extending from a body of the first lower end plate, and the two arms are spaced apart from the upper rail when the first lower end plate is connected to the first upper end plate and the upper rail is installed to the first upper end plate; and
the first upper connection counterpart comprises two protrusions, each protrusion adapted to engage one of the two hook-shaped structures.

6. The blind assembly of claim 1, further comprising:
a second upper end plate configured to effect installation of a second end of the upper rail, the first upper end plate and the second upper end plate cooperate such that the upper rail is installed between the first upper end plate and the second upper end plate; and
a second lower end plate removably connected to the second upper end plate, the second lower end plate configured to effect installation of a second end of the lower rail, the first lower end plate and the second lower end plate cooperate such that the lower rail is installed between the first lower end plate and the second lower end plate.

7. The blind assembly of claim 1, further comprising:
a first clutch disposed at the first end of the upper rail, the first clutch engages a first chain that extends from the first clutch; and
a second clutch disposed at the first end of the lower rail, the second clutch engages a second chain that extends from the second clutch.

8. The blind assembly of claim 7, further comprising a chain guide that guides the first chain such that the first chain and the second chain are spaced apart from each other.

9. The blind assembly of claim 8, wherein the chain guide guides the first chain to outside of the second chain.

10. The blind assembly of claim 8, wherein the chain guide guides the first chain to a side of the second chain.

11. The blind assembly of claim 8, wherein the chain guide is removably attached to the first lower end plate.

12. The blind assembly of claim 11, wherein:
the first lower end plate comprises a first coupling counterpart,
the chain guide comprises a second coupling counterpart, and
the first coupling counterpart and the second coupling counterpart cooperates such that the chain guide is removably attached to the first lower end plate.

13. The blind assembly of claim 12, wherein:
the first coupling counterpart comprises at least one U-shaped structure,
the second coupling counterpart comprises at least one tab, and
the first coupling counterpart cooperates with the second coupling counterpart by the tab engaging the respective U-shaped structure.

14. The blind assembly of claim 8, further comprising at least one fastener configured to effect the attachment between the chain guide and the first lower end plate.

15. The blind assembly of claim 8, wherein an adhesive is disposed between the chain guide and the first lower end plate.

16. A kit, comprising:
an upper end plate configured to effect installation of one end of an upper rail; and
a lower end plate configured to removably connect to the upper end plate, the lower plate configured to effect installation of one end of a lower rail.

17. The kit of claim 16, wherein
the upper end plate comprises an upper connection counterpart;
the lower end plate comprises a lower connection counterpart, and
the lower connection counterpart and upper connection counterpart cooperate such that lower end plate is removably connected to the upper end plate.

18. The kit of claim 17, wherein
the upper connection counterpart comprises at least one protrusion,
the lower connection counterpart comprises at least one hook-shaped structure, and
each of the at least one hook is adapted to removably connect to a respective one of the at least one protrusion.

19. The kit of claim 17, wherein
the lower connection counterpart is so sized and shaped such that the lower connection counterpart is spaced apart from the upper rail when the lower end plate is connected to the upper end plate.

20. An end plate for a blind assembly, the end plate configured to effect installation of one end of a first rail and to removably connect to a second end plate, the second end plate configured to effect installation of one end of a second rail.
